(19) United States
(12) Patent Application Publication
(10) Pub. No.: US 2024/0306710 A1
(43) Pub. Date: Sep. 19, 2024

(54) AEROSOL-GENERATING DEVICE

(71) Applicant: KT&G CORPORATION, Daejeon (KR)

(72) Inventors: Byungsung CHO, Gwangmyung-si Gyeonggi-do (KR); Jueon PARK, Seoul (KR); Jongsub LEE, Sungnam-si Gyeonggi-do (KR)

(73) Assignee: KT&G CORPORATION, Daejeon (KR)

(21) Appl. No.: 18/577,959

(22) PCT Filed: Jul. 21, 2022
(86) PCT No.: PCT/KR2022/010706

§ 371 Date: Jan. 9, 2024

(30) Foreign Application Priority Data
Jul. 22, 2021 (KR) 10-2021-0096333

(51) Int. Cl. A24F 40/42; A24D 1/20; A24F 40/10; A24F 40/20; A24F 40/44; A24F 40/46; A24F 40/485; A24F 40/51

(52) U.S. Cl. CPC A24F 40/42; A24D 1/20; A24F 40/10; A24F 40/20; A24F 40/44; A24F 40/46; A24F 40/485; A24F 40/51

(57) ABSTRACT

An aerosol-generating device is disclosed. The aerosol-generating device of the disclosure includes an elongated cartridge configured to accommodate a liquid, an elongated column beside the elongated cartridge, an insertion space disposed between the elongated cartridge and the elongated column, wherein the insertion space is defined by a portion of an outer wall of the elongated cartridge and a portion of an outer wall of the elongated column, a wick disposed at the elongated cartridge, wherein the wick is connected to an inside of the elongated cartridge, and a heater disposed near the wick and configured to apply heat to the wick.

### TECHNICAL FIELD

The present disclosure relates to an aerosol-generating device.

### BACKGROUND ART

An aerosol-generating device is a device that extracts certain components from a medium or a substance by forming an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol-generating devices has been conducted.

### DISCLOSURE OF INVENTION

### Technical Problem

It is an object of the present disclosure to solve the above and other problems.

It is another object of the present disclosure to provide an aerosol-generating device having a stick insertion space formed therein.

It is still another object of the present disclosure to provide an aerosol-generating device capable of sensing whether a stick is inserted thereinto.

### Solution to Problem

In accordance with an aspect of the present disclosure for accomplishing the above objects, there is provided an aerosol-generating device including an elongated cartridge configured to accommodate a liquid: an elongated column beside the elongated cartridge: an insertion space disposed between the elongated cartridge and the elongated column, wherein the insertion space is defined by a portion of an outer wall of the elongated cartridge and a portion of an outer wall of the elongated column; a wick disposed at the elongated cartridge, wherein the wick is connected to an inside of the elongated cartridge; and a heater disposed near the wick and configured to apply heat to the wick.

### Advantageous Effects of Invention

According to at least one of embodiments of the present disclosure, the capacity of a cartridge may be increased.

According to at least one of embodiments of the present disclosure, the size of an aerosol-generating device may be reduced.

According to at least one of embodiments of the present disclosure, the recognition rate of a sensor for sensing insertion of a stick may be improved.

Additional applications of the present disclosure will become apparent from the following detailed description. However, because various changes and modifications will be clearly understood by those skilled in the art within the spirit and scope of the present disclosure, it should be understood that the detailed description and specific embodiments, such as preferred embodiments of the present disclosure, are merely given by way of example.

### BRIEF DESCRIPTION OF DRAWINGS

The above and other objects, features, and other advantages of the present disclosure will be more clearly understood from the following detailed description taken in conjunction with the accompanying drawings, in which:

FIGS. 1 to 13 are views showing examples of an aerosol-generating device according to embodiments of the present disclosure.

### BEST MODE FOR CARRYING OUT THE INVENTION

Hereinafter, the embodiments disclosed in the present specification will be described in detail with reference to the accompanying drawings, and the same or similar elements are denoted by the same reference numerals even though they are depicted in different drawings, and redundant descriptions thereof will be omitted.

In the following description, with respect to constituent elements used in the following description, the suffixes “module” and “unit” are used only in consideration of facilitation of description, and do not have mutually distinguished meanings or functions.

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and sprit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

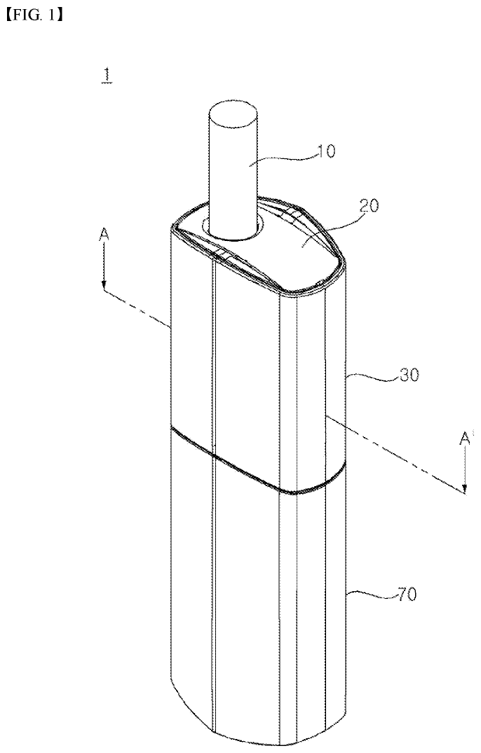

FIG. 1 is a perspective view of an aerosol-generating device 1 according to an embodiment of the present disclosure. Referring to FIG. 1, the aerosol-generating device 1 may include an upper casing 30, a lower casing 70, and a cap 20. A stick 10 may be inserted into the aerosol-generating device 1 through the cap 20.

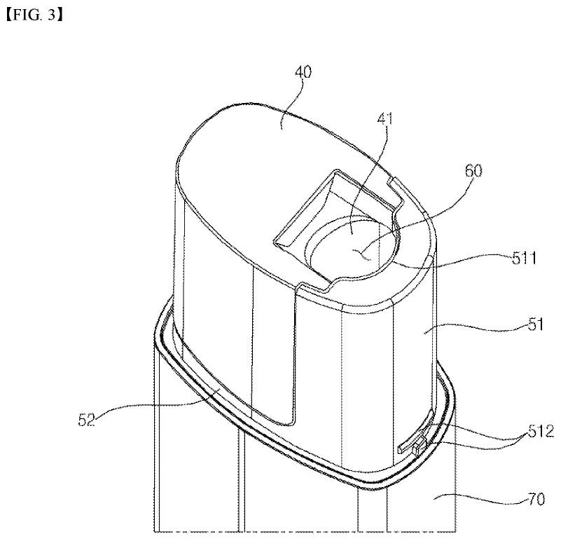

The cap 20 may be coupled to the upper side of the upper casing 30. The cap 20 may have formed therein a hole through which the stick 10 passes. The hole may communicate with an insertion space 60 (refer to FIG. 3) formed in the aerosol-generating device 1. The cap 20 may cover the upper side of the upper casing 30. The cap 20 may be coupled to the inside of the upper casing 30. The cap 20 may form the external appearance of the aerosol-generating device 1.

The upper casing 30 and the lower casing 70 may cover the inside of the aerosol-generating device 1. The upper casing 30 may be coupled to the upper side of the lower casing 70. A user may grip the upper casing 30 and the lower casing 70. The upper casing 30 and the lower casing 70 may form the external appearance of the aerosol-generating device 1. The upper casing 30 and the lower casing 70 may be formed of a light-transmissive material.

The user may inhale an aerosol generated in the aerosol-generating device 1 through the stick 10 inserted into the aerosol-generating device 1 while gripping the upper casing 30 and the lower casing 70.

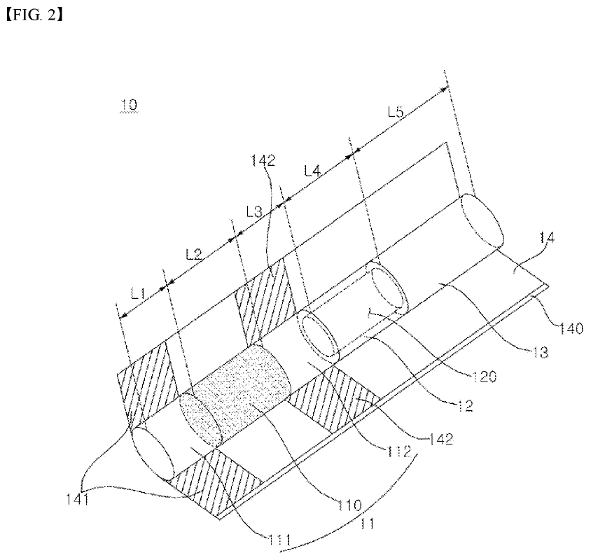

FIG. 2 is an exploded perspective view of the stick 10 according to an embodiment of the present disclosure. Referring to FIGS. 1 and 2, the stick 10 may include a medium portion 11. The stick 10 may include a cooling portion 12. The stick 10 may include a filter portion 14. The cooling portion 12 may be disposed between the medium portion 11 and the filter portion 14. The stick 10 may include a wrapper 13. The wrapper 13 may wrap the medium portion 11. The wrapper 13 may wrap the cooling portion 12. The wrapper 13 may wrap the filter portion 14. The stick 10 may have a cylindrical shape.

The medium portion 11 may include a medium 110. The medium portion 11 may include a first medium cover 111. The medium portion 11 may include a second medium cover 112. The medium 110 may be disposed between the first medium cover 111 and the second medium cover 112. The first medium cover 111 may be disposed at one end of the stick 10. The medium portion 11 may have a length of 24 mm.

The medium 110 may contain a multicomponent substance. The substance contained in the medium may be a multicomponent flavoring substance. The medium 110 may be composed of a plurality of granules. Each of the plurality of granules may have a size of 0.4 mm to 1.12 mm. The granules may account for approximately 70% of the volume of the medium 110. The length L2 of the medium 110 may be 10 mm. The first medium cover 111 may be made of an acetate material. The second medium cover 112 may be made of an acetate material. The first medium cover 111 may be made of a paper material. The second medium cover 112 may be made of a paper material. At least one of the first medium cover 111 or the second medium cover 112 may be made of a paper material, and may be crumpled so as to be wrinkled, and a plurality of gaps may be formed between the wrinkles so that air flows therethrough. Each of the gaps may be smaller than each of the granules of the medium 110. The length L1 of the first medium cover 111 may be shorter than the length L2 of the medium 110. The length L3 of the second medium cover 112 may be shorter than the length L2 of the medium 110. The length L1 of the first medium cover 111 may be 7 mm. The length L2 of the second medium cover 112 may be 7 mm.

Accordingly, each of the granules of the medium 110 may be prevented from being separated from the medium portion 11 and the stick 10.

The cooling portion 12 may have a cylindrical shape. The cooling portion 12 may have a hollow shape. The cooling portion 12 may be disposed between the medium portion 11 and the filter portion 14. The cooling portion 12 may be formed in the shape of a tube that surrounds a cooling path 120 formed therein. The cooling portion 12 may be thicker than the wrapper 13. The cooling portion 12 may be made of a paper material thicker than that of the wrapper 13. The length L4 of the cooling portion 12 may be equal or similar to the length L2 of the medium 110. The length L4 of each of the cooling portion 12 and the cooling path 120 may be 10 mm. When the stick 10 is inserted into the aerosol-generating device, at least part of the cooling portion 12 may be exposed to the outside of the aerosol-generating device.

Accordingly, the cooling portion 12 may support the medium portion 11 and the filter portion 14, and may secure the rigidity of the stick 10. In addition, the cooling portion 12 may support the wrapper 13 between the medium portion 11 and the filter portion 14, and may provide a portion to which the wrapper 13 is adhered. In addition, the heated air and aerosol may be cooled while passing through the cooling path 120 in the cooling portion 12.

The filter portion 14 may be composed of a filter made of an acetate material. The filter portion 14 may be disposed at the other end of the stick 10. When the stick 10 is inserted into the aerosol-generating device, the filter portion 14 may be exposed to the outside of the aerosol-generating device. The user may inhale air in the state of holding the filter portion 14 in the mouth. The length L5 of the filter portion 14 may be 14 mm.

The wrapper 13 may wrap or surround the medium portion 11, the cooling portion 12, and the filter portion 14. The wrapper 13 may form the external appearance of the stick 10. The wrapper 13 may be made of a paper material. An adhesive portion 130 may be formed along one edge of the wrapper 13. The wrapper 13 may surround the medium portion 11, the cooling portion 12, and the filter portion 14, and the adhesive portion 130 formed along one edge of the wrapper 13 and the other edge thereof may be adhered to each other. The wrapper 13, which wraps the medium portion 11, the cooling portion 12, and the filter portion 14, may not cover one end or the other end of the stick 10.

Accordingly, the wrapper 13 may fix the medium portion 11, the cooling portion 12, and the filter portion 14, and may prevent these components from being separated from the stick 10.

A first thin film 131 may be disposed at a position corresponding to the first medium cover 111. The first thin film 131 may be disposed between the wrapper 13 and the first medium cover 111, or may be disposed outside the wrapper 13. The first thin film 131 may surround the first medium cover 111. The first thin film 131 may be made of a metal material. The first thin film 131 may be made of an aluminum material. The first thin film 131 may be in close contact with the wrapper 13, or may be coated thereon.

A second thin film 132 may be disposed at a position corresponding to the second medium cover 112. The second thin film 132 may be disposed between the wrapper 13 and the second medium cover 112, or may be disposed outside the wrapper 13. The second thin film 132 may be made of a metal material. The second thin film 132 may be made of an aluminum material. The second thin film 132 may be in close contact with the wrapper 13, or may be coated thereon.

FIG. 3 is a perspective view of part of the aerosol-generating device 1 according to an embodiment of the present disclosure. Referring to FIG. 3, the aerosol-generating device 1 may include a cartridge 40, a column 51, a base 52, and an insertion space 60.

The cartridge 40 may accommodate a liquid, which is a raw material for generating an aerosol. The cartridge 40 may be mounted to the column 51 and/or the base 52. The cartridge 40 may be located in the upper casing 30. The cartridge 40 may include an outer wall 41. The liquid may be accommodated inside the outer wall 41 of the cartridge 40. The cartridge 40 may be formed of a light-transmissive material. The user may visually check the amount of liquid remaining in the cartridge 40. The cartridge 40 may be names as a elongated cartridge 40.

The column 51 may be located in the upper casing 30. The column 51 may accommodate the cartridge 40 in one side thereof. The column 51 may extend along the outer side of the cartridge 40. The column 51 may be elongated vertically. The column 51 may be elongated upwards from the base 52. The column 51 may include an outer wall 511. A portion of the outer wall 511 of the column 51 may be recessed in the inward direction of the column 51. The column 51 may be provided on the outer side surface thereof with a coupling portion 512. The coupling portion 512 of the column 51 may be coupled to the inside of the upper casing 30.

A portion of the outer wall 41 of the cartridge 40 and a portion of the outer wall 511 of the column 51 may define an insertion space 60, into which the stick 10 is inserted. The portion of the outer wall 41 of the cartridge 40 may be recessed in the inward direction of the cartridge 40. The portion of the outer wall 511 of the column 51 may be recessed in the inward direction of the column 51. The stick 10, which is inserted into the aerosol-generating device 1 through the cap 20, may be inserted into the insertion space 60.

The insertion space 60 may be defined by the portion of the outer wall 41 that corresponds to the side surface of the cartridge and the portion of the outer wall 511 that corresponds to the side surface of the column 51. The insertion space 60 may be located outside the cartridge 40. The insertion space 60 may be located outside the column 51. The portion of the outer wall 41 that corresponds to the side surface of the cartridge and the portion of the outer wall 511 that corresponds to the side surface of the column 51 may face the insertion space 60. The insertion space 60 may be disposed between the cartridge 40 and the column 51. The insertion space 60 may be formed to be long in the longitudinal direction of the column 51. That is, the insertion space 60 may be formed to long in the upward-downward direction.

The base 52 may support the cartridge 40. A portion of the cartridge 40 may be inserted into the base 52. The cartridge 40 may be mounted on the base 52. The upper casing 30 and the lower casing 70 may be coupled to the base 52. The column 51 may extend from one side of the base 52. The base 52 may be integrally formed with the column 51.

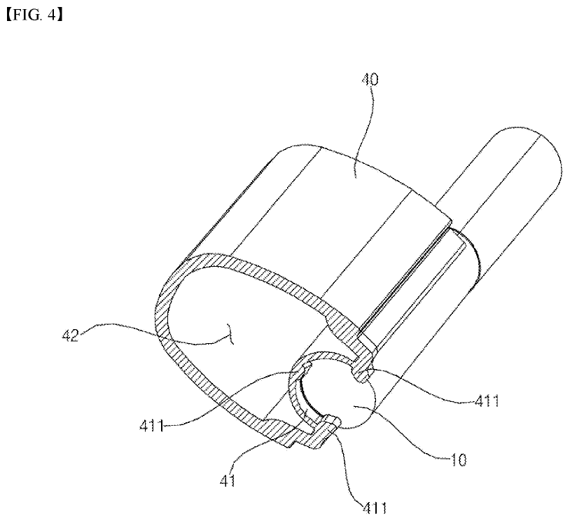

FIG. 4 is a cross-sectional view of part of the aerosol-generating device 1 according to an embodiment of the present disclosure. Referring to FIG. 4, the cartridge 40 may include an accommodation space 42 and a stopper 411.

The accommodation space 42 may accommodate a liquid that is used to generate an aerosol. The accommodation space 42 may be defined by the outer wall 41 of the cartridge 40. The accommodation space 42 may be formed in the cartridge 40.

The stopper 411 may protrude from the outer wall 41 of the cartridge 40. The stopper 411 may protrude toward the insertion space 60. The stopper 411 may support the stick 10 inserted into the insertion space 60. A plurality of stoppers 411 may be formed on the outer wall 41 of the cartridge 40. The upper surface of the stopper 411 may be formed to be flat. The flat upper surface of the stopper 411 may support the lower surface of the stick 10. A portion of the outer wall 41 of the cartridge 40 may support a portion of the side surface of the stick 10 inserted into the insertion space 60.

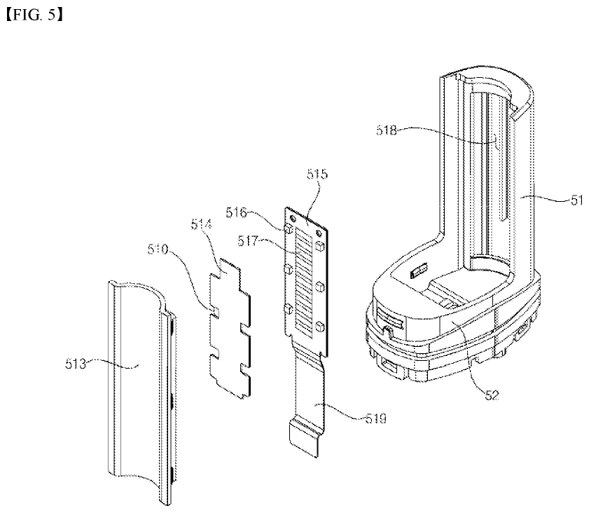

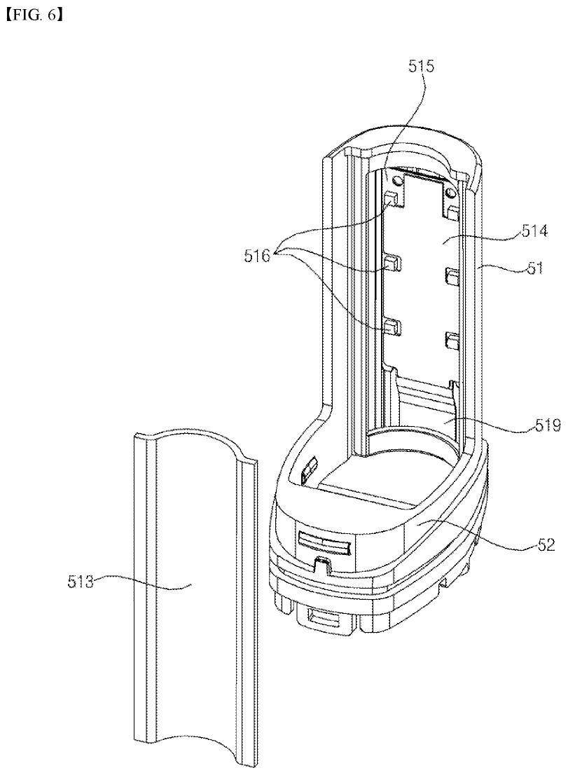

FIGS. 5 and 6 are exploded perspective views of a part of the aerosol-generating device 1 according to an embodiment of the present disclosure. Referring to FIGS. 5 and 6, the aerosol-generating device 1 may include a window 513, a plate 514, a printed circuit board (PCB) 515, a light source 516, a sensor 517, a mounting space 518, and a connector 519.

The window 513 may cover the inside of the column 51. The window 513 may be elongated in the longitudinal direction of the column 51. The window 513 may be formed of a light-transmissive material. The window 513 may protect the components mounted in the column 51. The window 513 may face the insertion space 60. The window 513 may provide the insertion space 60. The window 513 may be recessed in the inward direction of the column 51. The window 513 may be coupled to the outer wall of the column 51.

The window 513 may provide the insertion space 60. Since the window 513 is interposed between the insertion space 60 and the mounting space 518, in which the sensor 517 is mounted, the recognition rate and the reliability of the sensor 517 may be improved compared to the case in which other additional components are interposed between the insertion space 60 and the mounting space 518.

The plate 514 may be disposed in the mounting space 518. The plate 514 may cover the PCB 515. The plate 514 may have a plurality of grooves 510 formed therein. The light source 516 may be located in each of the plurality of grooves 510 in the plate 514. The plate 514 may cover the sensor 517. The plate 514 may not cover the light source 516. That is, the plate 514 may cover the sensor 517 while avoiding interference with the light source 516. The plate 514 may be elongated in the longitudinal direction of the column 51.

The plate 514 may be formed of a translucent material. The plate 514 may be formed of a material that blocks visible light and transmits electromagnetic waves. That is, the plate 514 may protect the PCB 515 and the sensor 517, and may not block the light from the light source 516.

The PCB 515 may be mounted in the mounting space 518 in the column 51. The PCB 515 may be a flexible printed circuit board (FPCB). The PCB 515 may extend in the longitudinal direction of the column 51. The PCB 515 may be connected to the light source 516 and to the sensor 517. The PCB 515 may be connected to a battery (not shown) via the connector 519. The battery may be located in the lower casing 70.

The light source 516 may be mounted on the PCB 515. A plurality of light sources 516 may be disposed. The light source 516 may radiate light toward the cartridge 40. The light radiated from the light source 516 may travel to the outside of the aerosol-generating device 1 through the cartridge 40 and the upper casing 30, which are formed of a light-transmissive material. Accordingly, the user may check the amount of liquid remaining in the cartridge 40 using the light from the light source 516, without disassembling the aerosol-generating device 1.

The sensor 517 may be mounted on the PCB 515. The sensor 517 may be disposed toward the insertion space 60. The sensor 517 may face the insertion space 60. The sensor 517 may sense a change in electromagnetic characteristics around the sensor 517. When the stick 10 is inserted into the insertion space 60, the electromagnetic characteristics around the sensor 517 are changed by the first thin film 131 and the second thin film 132 of the stick 10, whereby the sensor 517 senses insertion of the stick 10.

The mounting space 518 may be located in the column 51. The mounting space 518 may be defined by the outer wall 511 of the column 51 and the window 513. The PCB 515 and the plate 514 may be mounted in the mounting space 518. The mounting space 518 may be formed to be long in the column 51.

One end of the connector 519 may be connected to the PCB 515. The other end of the connector 519 may be exposed to an area below the base 52. The connector 519 may connect the PCB 515 to other components provided inside the aerosol-generating device 1. The connector 519 may connect the PCB 515 to the battery and to a controller (not shown).

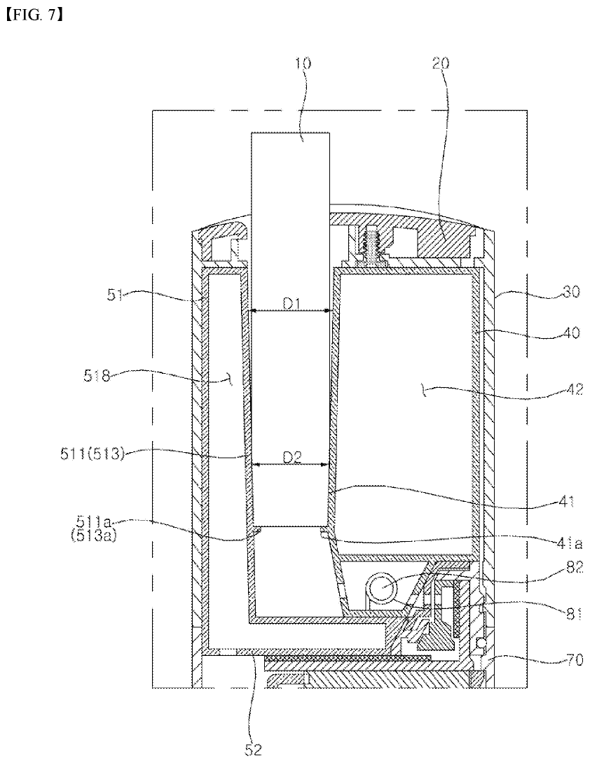

FIG. 7 is a cross-sectional view of the aerosol-generating device 1 according to an embodiment of the present disclosure. Referring to FIG. 7, the aerosol-generating device 1 may include a heater 81, a wick 82, and stoppers 513a and 411.

The heater 81 may be located in the cartridge 40. The heater 81 may be disposed near the wick 82. The heater 81 may receive power from the battery to generate heat. The heater 81 may apply heat to the wick 82. The heater 81 may be formed so as to be wound around the wick 82. The heater 81 may be located in the lower portion of the cartridge 40. The heater 81 may be located outside the cartridge 40, or only a part of the heater 81 may be located inside the cartridge 40.

The wick 82 may be located in the cartridge 40. A portion of the wick 82 may be connected to the accommodation space 42 in the cartridge 40. The wick 82 may absorb the liquid accommodated in the accommodation space 42. The wick 82 may be elongated. The wick 82 may be located in the lower portion of the cartridge 40. The wick 82 may communicate with the insertion space 60. The wick 82 may be spaced apart from the insertion space 60 in the radial direction of the insertion space 60.

A portion of the outer wall 511 of the column 51 may include the stopper 511a. The window 513 may include the stopper 513a. The stoppers 511a and 513a may protrude toward the cartridge 40. The stoppers 511a and 513a may protrude toward the insertion space 60. The stoppers 511a and 513a may support the stick 10 inserted into the insertion space 60. The stoppers 511a and 513a may limit the extent of insertion of the stick 10. The stoppers 511a and 513a may be formed in a plural number.

The stopper 411 may protrude from a portion of the outer wall 41 of the cartridge 40. The stopper 411 may protrude toward the column 51. The stopper 411 may protrude toward the insertion space 60. The stopper 411 may support the stick 10 inserted into the insertion space 60. The stopper 411 may limit the extent of insertion of the stick 10. The stopper 411 may be formed in a plural number. The stoppers 511a and 513a formed at the column 51 and the stopper 411 formed at the cartridge 40 may face each other.

The portion of the outer wall 41 of the cartridge 40 that defines the insertion space 60 may be inclined so as to gradually approach the column 51 from the upper side thereof to the lower side thereof. The portion of the outer wall 511 of the column 51 that defines the insertion space 60 may be inclined so as to gradually approach the cartridge 40 from the upper side thereof to the lower side thereof. That is, the portion of the outer wall 41 of the cartridge 40 and the portion of the outer wall 511 of the column 51 may be inclined so as to gradually approach each other in a direction approaching the inside of the aerosol-generating device 1.

Accordingly, the cross-sectional area of the insertion space 60 may gradually decrease from the upper side thereof to the lower side thereof. The size D1 of the upper portion of the insertion space 60 may be larger than the size D2 of the lower portion of the insertion space 60. When the stick 10 is inserted into the insertion space 60, the stick 10 may come into close contact with the lower portion of the insertion space 60, and the portion of the outer wall 41 of the cartridge 40 and the portion of the outer wall 511 of the column 51 may support the side surface of the stick 10.

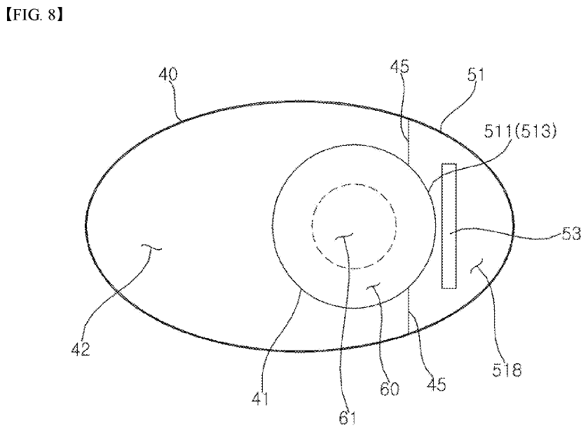

FIG. 8 is a schematic view of the aerosol-generating device 1 according to an embodiment of the present disclosure. FIG. 8 shows the case in which the insertion space 60 is defined by a portion of the outer wall 41 of the cartridge 40 and a portion of the outer wall 511 of the column 51 or the window 513.

Referring to FIG. 8, the aerosol-generating device 1 may include a contact portion 45, a sensing unit 53, and a center portion 61 of the insertion space 60.

The contact portion 45 may be in close contact with the outer wall of the column 51. The contact portion 45 may be located outside the insertion space 60. The contact portion 45 may close the insertion space 60. The insertion space 60 may be defined by a portion of the outer wall 41 of the cartridge 40, a portion of the outer wall 511 of the column 51, and the contact portion 45. Since two contact portions 45 are formed by the cartridge 40 and the column 51, it may be easy to seal the insertion space 60.

The sensing unit 53 may be mounted in the mounting space 518. The sensing unit 53 may include the plate 514, the PCB 515, the light source 516, and the sensor 517, which are disposed in the mounting space 518. The sensing unit 53 may sense whether the stick 10 is inserted into the insertion space 60.

The center portion 61 of the insertion space 60 may be adjacent to the outer wall 41 of the cartridge 40. The center portion 61 of the insertion space 60 may be adjacent to the accommodation space 42 in the cartridge 40. The center portion 61 of the insertion space 60 may be located outside the column 51. Accordingly, the size of the mounting space 518 may be minimized, and thus the size of the aerosol-generating device 1 may be reduced.

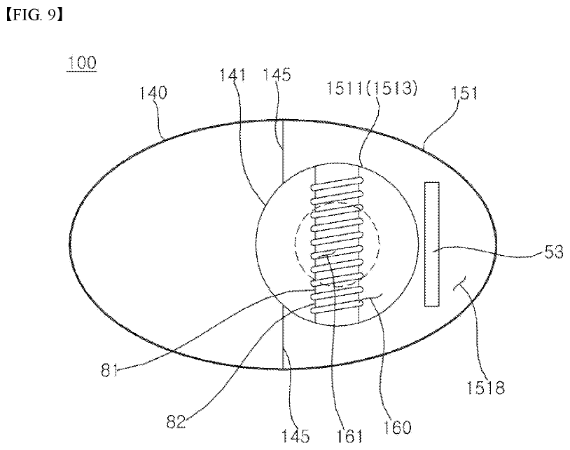

FIG. 9 is a schematic view of part of an aerosol-generating device 100 according to another embodiment of the present disclosure. FIG. 9 shows the case in which an insertion space 160 is defined by a portion of an outer wall 141 of a cartridge 140 and a portion of an outer wall 1511 of a column 151.

Referring to FIG. 9, the center portion 161 of the insertion space 160 may be adjacent to a mounting space 1518. The center portion 161 of the insertion space 160 may be adjacent to the sensing unit 53 mounted in the column 151. The cartridge 140 may include a contact portion 145 that abuts the column 151. The center portion 161 of the insertion space 160 may be located outside the cartridge 140. Accordingly, the capacity of the cartridge 140 may increase.

The heater 81 and the wick 82 may be located below the insertion space 160. When the heater 81 applies heat to the wick 82 impregnated with the liquid, the liquid may be vaporized to generate an aerosol, and the aerosol may rise into the insertion space 160. After inserting the stick 10, the user may operate the heater 81 to inhale the aerosol through the stick 10.

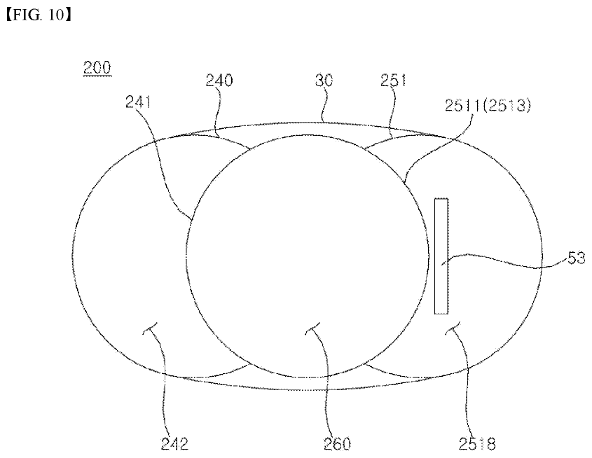

FIG. 10 is a schematic view of part of an aerosol-generating device 200 according to still another embodiment of the present disclosure. FIG. 10 shows the case in which an insertion space 260 is defined by a portion of an outer wall 241 of a cartridge 240, a portion of an outer wall 2511 of a column 251, and a portion of the inner wall of the upper casing 30.

Referring to FIG. 10, a portion of the outer wall 241 of the cartridge 240 and a portion of the outer wall 2511 of the column 251 may define the insertion space 260. The portion of the outer wall 241 of the cartridge 240 and the portion of the outer wall 2511 of the column 251 may be spaced apart from each other. A portion of the inner wall of the upper casing 30 may define the insertion space 260. When another component (not shown) is coupled to the inner wall of the upper casing 30, the insertion space 260 may also be defined by the other component.

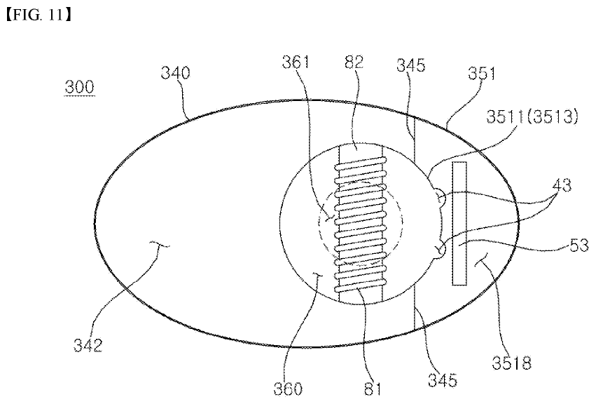

FIG. 11 is a schematic view of part of an aerosol-generating device 300 according to still another embodiment of the present disclosure. FIG. 11 shows the case in which a slit 43 is formed in a portion of an outer wall 3511 of a column 351 or in a window 3513.

Referring to FIG. 11, the slit 43 may be formed in a portion of the outer wall 3511 of the column 351 or in the window 3513. The slit 43 may extend in the longitudinal direction of the column 351. Air may flow into the slit 43. The slit 43 may communicate with an insertion space 360. When the stick 10 is inserted into the insertion space 360, the stick 10 may come into contact with the slit 43. The slit 43 may communicate with the outside of the aerosol-generating device 300. The slit 43 may communicate with the hole formed in the cap 20. Air outside the aerosol-generating device 300 may flow into the insertion space 360 through the slit 43. The slit 43 may allow the hole and the lower side of the insertion space 360 to communicate with each other therethrough.

The heater 81 and the wick 82 may be located below the insertion space 360. When the heater 81 applies heat to the wick 82 impregnated with the liquid, the liquid may be vaporized to generate an aerosol, and the aerosol may rise into the insertion space 360. After inserting the stick 10, the user may operate the heater 81 to inhale the aerosol through the stick 10.

When the user inserts the stick 10 into the aerosol-generating device 300 and then sucks the stick 10, air outside the aerosol-generating device 300 may flow to the periphery of the wick 82 through the slit 43, and the air and vapor resulting from vaporization of the liquid by the heater 81 may pass through the stick 10, and may be inhaled by the user.

The center portion 361 of the insertion space 360 may be adjacent to an outer wall 341 of a cartridge 340. The center portion 361 of the insertion space 360 may be adjacent to an accommodation space 342 in the cartridge 340. The center portion 361 of the insertion space 360 may be located outside the column 351. Accordingly, the size of a mounting space 3518 may be minimized, and thus the size of the aerosol-generating device 300 may be reduced.

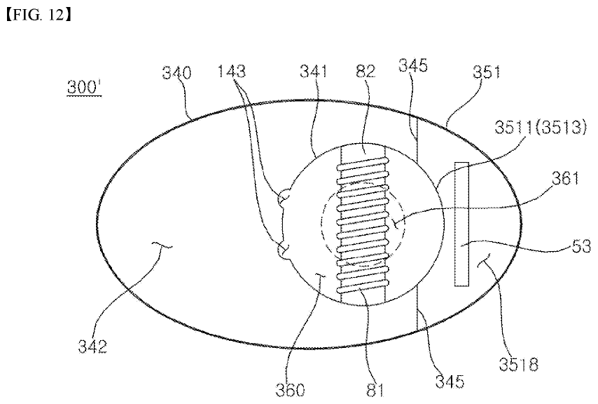

FIG. 12 is a schematic view of part of an aerosol-generating device 300′ according to still another embodiment of the present disclosure. FIG. 12 shows the case in which a slit 143 is formed in a portion of an outer wall 341 of a cartridge 340.

Referring to FIG. 12, the slit 143 may be formed in a portion of the outer wall 341 of the cartridge 340. The slit 143 may extend in the longitudinal direction of the cartridge 340. The slit 143 may extend in the longitudinal direction of the column 351. Air may flow into the slit 143. The slit 143 may communicate with the insertion space 360. When the stick 10 is inserted into the insertion space 360, the stick 10 may come into contact with the slit 143. The slit 143 may communicate with the outside of the aerosol-generating device 300′. The slit 143 may communicate with the hole formed in the cap 20. Air outside the aerosol-generating device 300′ may flow into the insertion space 360 *?* through the slit 143.

The heater 81 and the wick 82 may be located below the insertion space 360. When the heater 81 applies heat to the wick 82 impregnated with the liquid, the liquid may be vaporized to generate an aerosol, and the aerosol may rise into the insertion space 360. After inserting the stick 10, the user may operate the heater 81 to inhale the aerosol through the stick 10.

When the user inserts the stick 10 into the aerosol-generating device 300′ and then sucks the stick 10, air outside the aerosol-generating device 300′ may flow to the periphery of the wick 82 through the slit 143, and the air and vapor resulting from vaporization of the liquid by the heater 81 may pass through the stick 10, and may be inhaled by the user.

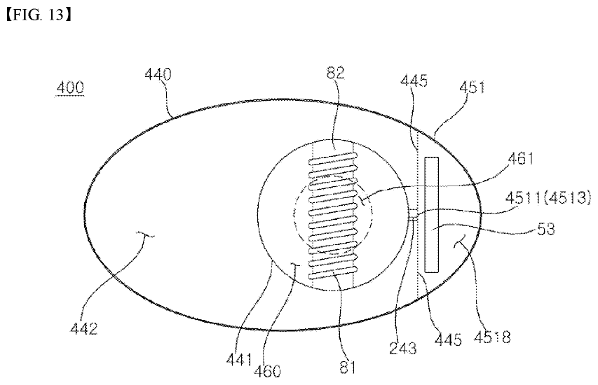

FIG. 13 is a schematic view of part of an aerosol-generating device 400 according to still another embodiment of the present disclosure. FIG. 13 shows the case in which a slit 243 is formed in a portion of an outer wall 441 of a cartridge 440.

Referring to FIG. 13, the slit 243 may be formed in a portion of the outer wall 441 of the cartridge 440. The slit 243 may extend in the longitudinal direction of the cartridge 440. The slit 243 may extend in the longitudinal direction of the column 451. Air may flow into the slit 243. The slit 243 may communicate with an insertion space 460. The slit 243 may allow the insertion space 460 and the outside of the cartridge 440 to communicate with each other therethrough. The slit 243 may abut a portion of an outer wall 4511 of a column 450 or a window 4513.

When the stick 10 is inserted into the insertion space 460, the stick 10 may come into contact with the slit 243. The slit 243 may communicate with the outside of the aerosol-generating device 400. The slit 243 may communicate with the hole formed in the cap 20. Air outside the aerosol-generating device 400 may flow into the insertion space 460 through the slit 243.

The heater 81 and the wick 82 may be located below the insertion space 460. When the heater 81 applies heat to the wick 82 impregnated with the liquid, the liquid may be vaporized to generate an aerosol, and the aerosol may rise into the insertion space 460. After inserting the stick 10, the user may operate the heater 81 to inhale the aerosol through the stick 10.

When the user inserts the stick 10 into the aerosol-generating device 400 and then sucks the stick 10, air outside the aerosol-generating device 400 may flow to the periphery of the wick 82 through the slit 243, and the air and vapor resulting from vaporization of the liquid by the heater 81 may pass through the stick 10, and may be inhaled by the user.

Referring to FIGS. 1 to 13, an aerosol-generating device 1 in accordance with one aspect of the present disclosure may include an elongated cartridge 40 configured to accommodate a liquid, an elongated column 51 beside the elongated cartridge 40, an insertion space 60 disposed between the elongated cartridge 40 and the elongated column 51, wherein the insertion space 60 may be defined by the portion of the outer wall 41 of the elongated cartridge 40 and the portion of the outer wall 511 of the elongated column 51, a wick 82 disposed at the elongated cartridge 40, wherein the wick 82 may be connected to the inside of the elongated cartridge 40, and a heater 81 disposed near the wick 82 and configured to apply heat to the wick 82.

In addition, in accordance with another aspect of the present disclosure, the aerosol-generating device may further include a window 513 coupled to the portion of the outer wall 511 of the column 51 that faces the insertion space 60, wherein the window 513 may comprise a light-transmissive material, and a first sensor 517 installed inside the elongated column 51, wherein the first sensor 517 may be configured to sense an insertion of the stick 10 into the insertion space 60.

In addition, in accordance with another aspect of the present disclosure, the aerosol-generating device may further include a light source 516 mounted in the elongated column 51 configured to radiate light toward the elongated cartridge 40.

In addition, in accordance with another aspect of the present disclosure, wherein the outer wall 41 of the elongated cartridge 40 may be in contact with the outer wall 511 of the elongated column 51.

In addition, in accordance with another aspect of the present disclosure, the center portion 161 of the insertion space 160 may be located outside the elongated cartridge 140.

In addition, in accordance with another aspect of the present disclosure, the center portion 61 of the insertion space 60 may be located outside the elongated column 51.

In addition, in accordance with another aspect of the present disclosure, the window 3513 may include an elongated slit 43 extending along the longitudinal direction of the elongated column 351 and may provide a flow path in communication with an outside of the aerosol-generating device and the wick through the elongated slit.

In addition, in accordance with another aspect of the present disclosure, the elongated cartridge 340 may include an elongated slit 143 extending along the longitudinal direction of the elongated cartridge 340 and may provide a flow path in communication with an outside of the aerosol-generating device and the wick through the elongated slit.

In addition, in accordance with another aspect of the present disclosure, wherein the portion of the outer wall 41 of the elongated cartridge 40 and the portion of the outer wall 511 of the elongated column 51 may be inclined to decrease in the longitudinal direction of the elongated column 51 toward the inside of the aerosol-generating device 1.

In addition, in accordance with another aspect of the present disclosure, at least one of the outer wall 41 of the elongated cartridge 40 or the outer wall 511 of the elongated column 51 may include stoppers 411, 511a, and 513a protruding to the insertion space 60.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An aerosol-generating device comprising:
an elongated cartridge configured to accommodate a liquid;
an elongated column beside the elongated cartridge;
an insertion space disposed between the elongated cartridge and the elongated column, wherein the insertion space is defined by a portion of an outer wall of the elongated cartridge and a portion of an outer wall of the elongated column;
a wick disposed at the elongated cartridge, wherein the wick is connected to an inside of the elongated cartridge; and
a heater disposed near the wick and configured to apply heat to the wick.

2. The aerosol-generating device according to claim 1, further comprising:
a window coupled to the portion of the outer wall of the elongated column that faces the insertion space, wherein the window comprises a light-transmissive material; and
a first sensor installed inside the elongated column, wherein the first sensor is configured to sense an insertion of a stick into the insertion space.

3. The aerosol-generating device according to claim 2, further comprising:
a light source mounted in the elongated column configured to radiate light toward the elongated cartridge.

4. The aerosol-generating device according to claim 1, wherein the outer wall of the elongated cartridge is in contact with the outer wall of the elongated column.

5. The aerosol-generating device according to claim 1, wherein a center portion of the insertion space is located outside the elongated cartridge.

6. The aerosol-generating device according to claim 1, wherein a center portion of the insertion space is located outside the elongated column.

7. The aerosol-generating device according to claim 2, wherein the window comprises an elongated slit extending along a longitudinal direction of the elongated column and provides a flow path in communication with an outside of the aerosol-generating device and the wick through the elongated slit.

8. The aerosol-generating device according to claim 2, wherein the elongated cartridge comprises an elongated slit extending along a longitudinal direction of the elongated cartridge and provides a flow path in communication with an outside of the aerosol-generating device and the wick through the elongated slit.

9. The aerosol-generating device according to claim 1, wherein the portion of the outer wall of the elongated cartridge and the portion of the outer wall of the elongated column are inclined to decrease in a longitudinal direction of the elongated column toward an inside of the aerosol-generating device.

10. The aerosol-generating device according to claim 9, wherein at least one of the outer wall of the elongated cartridge or the outer wall of the elongated column comprises a stopper protruding toward the insertion space.
